(19) United States
(12) Patent Application Publication
(10) Pub. No.: US 2025/0062569 A1
(43) Pub. Date: Feb. 20, 2025

(54) ELECTRICAL CONNECTION APPARATUS AND PLUG CONNECTOR

(71) Applicant: Changchun Jetty Automotive Technology Co., Ltd., Changchun, Jilin (CN)

(72) Inventor: Chao WANG, Changchun, Jilin (CN)

(73) Assignee: Changchun Jetty Automotive Technology Co., Ltd., Changchun, Jilin (CN)

(21) Appl. No.: 18/725,735

(22) PCT Filed: Dec. 28, 2022
(86) PCT No.: PCT/CN2022/142645

§ 371 Date: Jun. 28, 2024

(30) Foreign Application Priority Data
Dec. 30, 2021 (CN) 202111659974.7

(51) Int. Cl. H01R 13/627; H01R 13/52; H01R 13/633; H01R 13/6592

(52) U.S. Cl. CPC H01R 13/6275; H01R 13/633; H01R 13/5202; H01R 13/6592

(57) ABSTRACT

The present disclosure provides an electrical connection apparatus and a plug connector, the electrical connection apparatus comprising: a socket connector and a plug connector, the socket connector comprising a socket housing, the plug connector comprising a plug housing and a detent, and a front end of the plug housing being plugged into the socket housing; an outer wall of the socket housing is provided with a first lock catch; the plug housing is provided with a first torsion bar mechanism, the first torsion bar mechanism being provided with a first lock hook, the first lock hook being snapped at a front side of the first lock catch, and the first torsion bar mechanism is capable of driving the first lock hook to separate from the first lock catch; the detent is provided with a first boss, and is connected with the plug housing.

### RELATED APPLICATION

The present disclosure claims the priority of the Chinese Patent Application with the application No. 202111659974.7, filed on Dec. 30, 2021 and entitled “ELECTRICAL CONNECTION APPARATUS AND PLUG CONNECTOR”.

### TECHNICAL FIELD

The present disclosure relates to the technical field of power electronic components, in particular to an electrical connection apparatus and a plug connector.

### BACKGROUND

A high voltage interlocking connector includes a plug connector and a socket connector, the plug connector is provided with a terminal, and via the plug connector and the socket connector, connection and disconnection between an interlocking signal circuit and a power circuit are realized. Currently, in order to guarantee safety, a structure of the high-voltage interlocking connector is more complex, and the manufacturing cost is higher.

### SUMMARY OF INVENTION

A purpose of the present disclosure is to provide an electrical connection apparatus and a plug connector, so as to solve the technical problems that a structure of a high-voltage interlocking connector is more complex, and the manufacturing cost is higher.

The purpose of the present disclosure may be realized by using the following technical solutions:

The present disclosure provides an electrical connection apparatus, including: a socket connector and a plug connector, the socket connector including a socket housing, the plug connector including a plug housing and a detent, and a front end of the plug housing being plugged into the socket housing; an outer wall of the socket housing is provided with a first lock catch; the plug housing is provided with a first torsion bar mechanism, the first torsion bar mechanism being provided with a first lock hook, the first lock hook being snapped at a front side of the first lock catch, to prevent the plug housing from moving backward with respect to the socket housing, and the first torsion bar mechanism is capable of driving the first lock hook to separate from the first lock catch under an action of an external force; the detent is provided with a first boss, and is connected with the plug housing, the first boss is capable of preventing the first torsion bar mechanism from moving under an action of an external force.

The present disclosure provides a plug connector, including: a plug housing and a detent, the plug housing being provided with a first torsion bar mechanism, the first torsion bar mechanism being provided with a first lock hook, and the first torsion bar mechanism being capable of driving the first lock hook to move under an action of an external force; the detent is provided with a first boss, the detent is connected with the plug housing and is limited via a damping structure, the damping structure is capable of preventing the first boss from deviating from the first torsion bar mechanism, and the first boss is capable of preventing the first torsion bar mechanism from moving under an action of an external force.

Features and advantages of the present disclosure are:

In the electrical connection apparatus, the plug housing is locked with the socket housing via the detent. When unlocking, an operator applies an external force to make the detent move, and applies an external force to the first torsion bar mechanism, the first torsion bar mechanism drives the first lock hook to separate from the first lock catch, realizing unlocking of the first lock hook and the first lock catch. The electrical connection apparatus can ensure the safety of locking and disconnection of electrical connection, is convenient to operate, has a simpler structure and reduces the manufacturing cost.

### BRIEF DESCRIPTION OF DRAWINGS

The following drawings are intended only to schematically illustrate and explain the present disclosure and do not limit the scope of the present disclosure. In which:

FIG. 1 is an exploded view of an electrical connection apparatus provided by the present disclosure;

FIG. 2 to FIG. 3 are schematic diagrams of a first state of an electrical connection apparatus provided by the present disclosure;

FIG. 4 is a left view of FIG. 2;

FIG. 5 is a right view of FIG. 2;

FIG. 6 to FIG. 8 are schematic diagrams of a second state of an electrical connection apparatus provided by the present disclosure;

FIG. 9 to FIG. 10 are schematic diagrams of a third state of an electrical connection apparatus provided by the present disclosure;

FIG. 11 to FIG. 18 are structural schematic diagrams of a plug housing in an electrical connection apparatus provided by the present disclosure;

FIG. 19 is a structural schematic diagrams of a socket housing in an electrical connection apparatus provided by the present disclosure;

FIG. 20 to FIG. 21 are structural schematic diagrams of a detent in an electrical connection apparatus provided by the present disclosure;

FIG. 22 is a structural schematic diagrams of a TPA snap ring in an electrical connection apparatus provided by the present disclosure;

FIG. 23 to FIG. 24 are structural schematic diagrams of a plug tail cover in an electrical connection apparatus provided by the present disclosure;

FIG. 25 is an axonometrical diagram of a plug housing in an electrical connection apparatus provided by the present disclosure.

### DETAILED DESCRIPTION

In order to have a clearer understanding on the technical features, purpose and effect of the present disclosure, now the specific embodiments of the present disclosure are illustrated with reference to the drawings. In the description of the present disclosure, unless otherwise explained. “a plurality of” means two or more.

### Solution 1

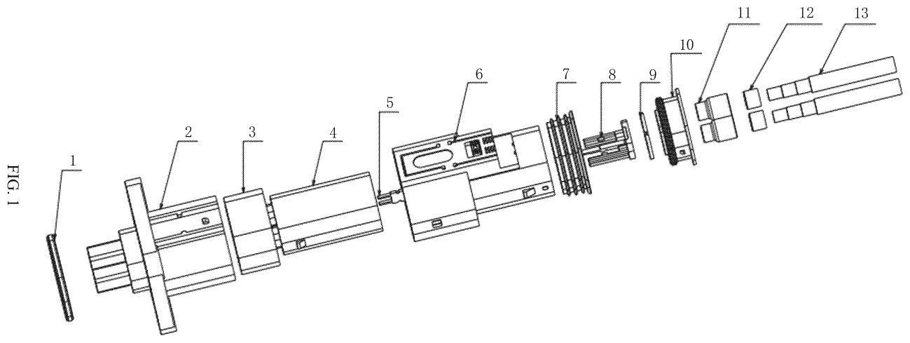

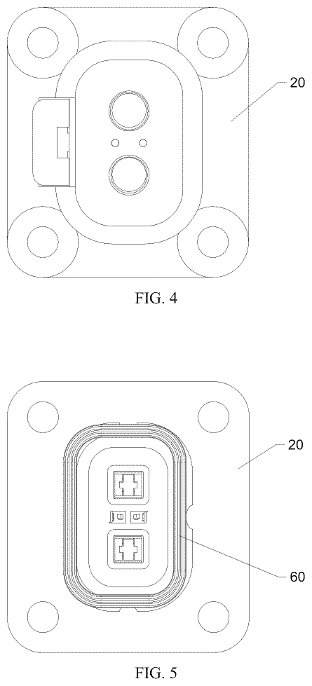

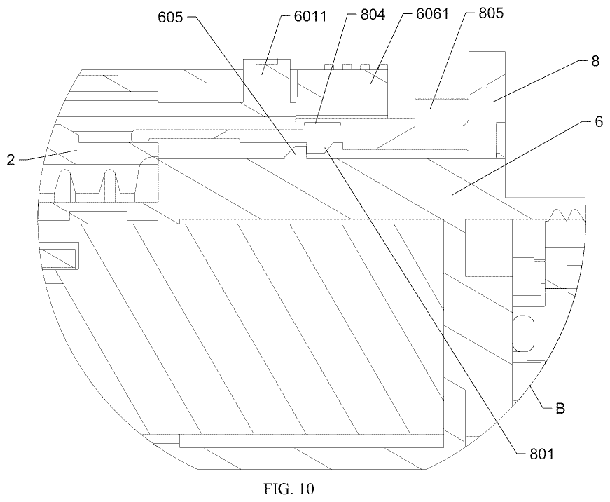

The present disclosure provides an electrical connection apparatus, as shown in FIG. 1 to FIG. 12, the electrical connection apparatus includes: a socket connector 20 and a plug connector 60, the socket connector 20 including a socket housing 2, the plug connector 60 comprising a plug housing 6 and a detent 8, and a front end of the plug housing 6 being plugged into the socket housing 2; an outer wall of the socket housing 2 is provided with a first lock catch 201; the plug housing 6 is provided with a first torsion bar mechanism 601, the first torsion bar mechanism 601 being provided with a first lock hook 602, the first lock hook 602 being snapped at a front side of the first lock catch 201, to prevent the plug housing 6 from moving backward with respect to the socket housing 2, and the first torsion bar mechanism 601 is capable of driving the first lock hook 602 to separate from the first lock catch 201 under an action of an external force; the detent 8 is provided with a first boss 804, and is connected with the plug housing 6, the first boss 804 is capable of preventing the first torsion bar mechanism 601 from moving under an action of an external force.

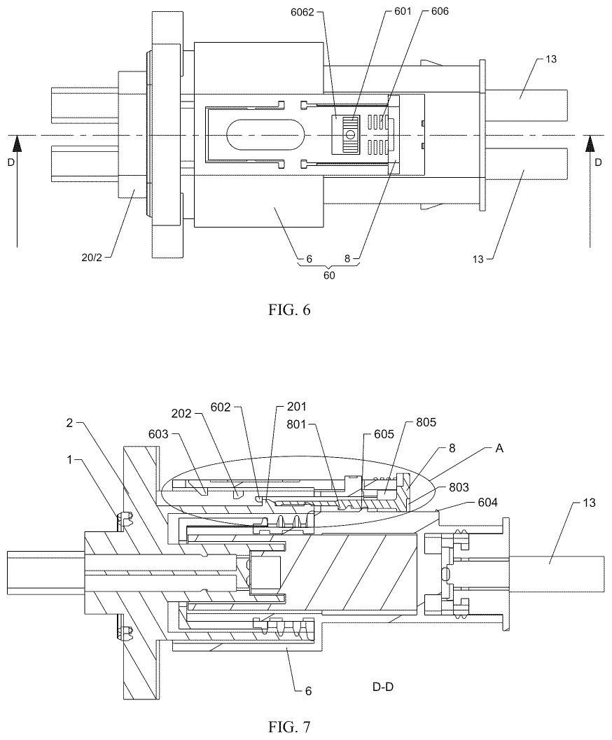

After pushing the detent 8 forward into place, as shown in FIG. 6 to FIG. 8, the position of the detent 8 remains stable, the first boss 804 on the detent 8 stabilizes the first torsion bar mechanism 601, so that the first lock hook 602 is confined to a front side of the first lock catch 201, and the plug housing 6 cannot move backwards with respect to the socket housing 2, keeping locked between the two. When unlocking, an operator applies an external force to make the detent 8 move relative to the plug housing 6, and the first boss 804 deviates from the first torsion bar mechanism 601; then, the operator applies an external force on the first torsion bar mechanism 601, and the first torsion bar mechanism 601 drives the first lock hook 602 to move to separate from the first lock catch 201, unlocking of the first lock hook 602 and the first lock catch 201 is realized, and the plug housing 6 may move backward relative to the socket housing 2 to disconnect the plug connector 60 from the socket connector 20. The electrical connection apparatus can ensure the safety of locking and disconnection of electrical connection, is convenient to operate, has a simpler structure and reduces the manufacturing cost.

In an implementation, the detent 8 and the plug housing 6 are limited via a damping structure 80, the damping structure 80 is capable of preventing the first boss 804 from deviating from the first torsion bar mechanism 601, as shown in FIG. 6 to FIG. 8, a position of the detent 8 is kept stable under the action of the damping structure 80; the operator applies an external force to overcome a resistance generated by the damping structure 80, which can cause the detent 8 to move with respect to the plug housing 6, thereby causing the first boss 804 to deviate from the first torsion bar mechanism 601.

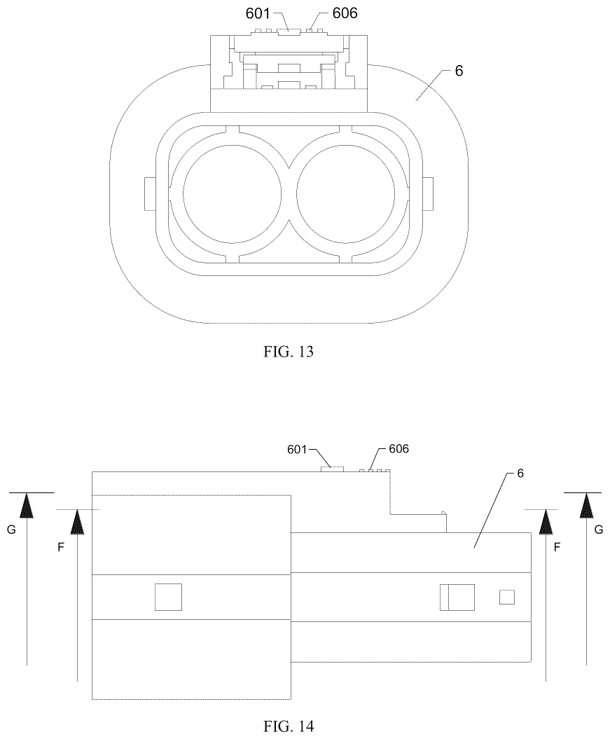

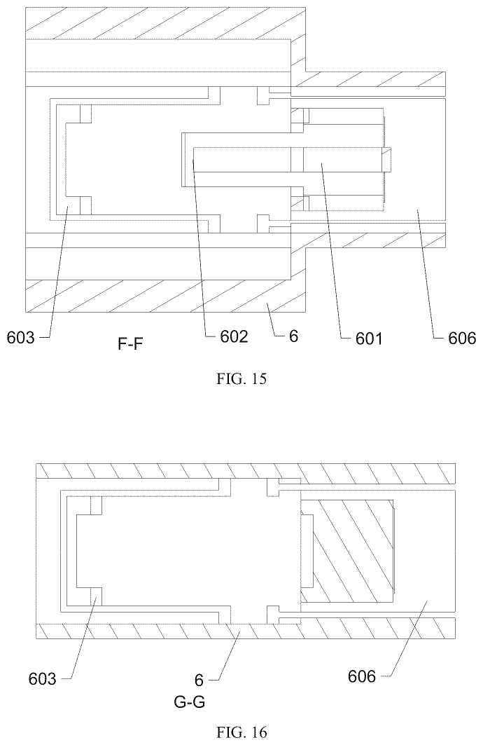

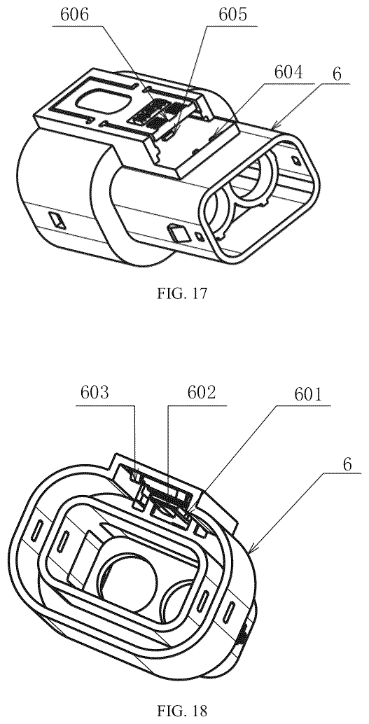

As shown in FIG. 1 to FIG. 18, an outer wall of the socket housing 2 is provided with a second lock catch 202; the plug housing 6 is provided with a second torsion bar mechanism 606, the second torsion bar mechanism 606 being provided with a second lock hook 603, the second lock hook 603 being snapped at a front side of the second lock catch 202, to prevent the plug housing 6 from moving backward with respect to the socket housing 2, and the second torsion bar mechanism 606 is capable of driving the second lock hook 603 to separate from the second lock catch 202 under an action of an external force; the detent 8 is provided with a second boss 805, the damping structure 80 is capable of preventing the second boss 805 from deviating from the second torsion bar mechanism 606, and the second boss 805 is capable of preventing the second torsion bar mechanism 606 from moving under an action of an external force.

After pushing the detent 8 forward into place, the second boss 805 on the detent 8 stabilizes the first torsion bar mechanism 601, the second lock hook 603 is confined to a front side of the second lock catch 202, and both the second lock hook 603 and the first lock hook 602 have a confining role on the position of the plug housing 6. When unlocking, the first boss 804 deviates from the first torsion bar mechanism 601, and the second boss 805 deviates from the second torsion bar mechanism 606. At this moment, the operator applies an external force to the first torsion bar mechanism 601 and the second torsion bar mechanism 606 respectively, to make the first lock hook 602 separated from the first lock catch 201, and the second lock hook 603 is separated from the second lock catch 202 to achieve unlocking.

The electrical connection apparatus operates the first torsion bar mechanism 601 and the second torsion bar mechanism 606 respectively to unlock, realizing a secondary lock function. When a high-voltage interlocking connector is unlocked, there is a time interval when an interlocking signal circuit and a power circuit are disconnected. During the unlocking and unplugging process, a phenomenon that a connector is electrically unplugged may occur. When the electrical connection apparatus is unlocked, unlocking twice is realized via the first torsion bar mechanism 601 and the second torsion bar mechanism 606, the plug connector 60 is unplugged from the adapted socket connector 20, which can realize step-by-step disconnection of high-voltage interlocking and a power terminal, so as to avoid a phenomenon of being electrically unplugged, and reduce the risks of ablation of a contact or connector and injury to a vehicle and an operator. The first torsion bar mechanism 601 and the second torsion bar mechanism 606 are unlocked respectively to achieve secondary separation, the operation is easy, and when one of them is damaged, the other can play a protective role, which improves the locking safety.

The damping structure 80 is capable of generating a certain magnitude of resistance to prevent the detent 8 from moving to a rear side with respect to the plug housing 6, and when the operator applies a large enough external force to the detent 8 to overcome the resistance generated by the damping structure 80, the detent 8 can be driven to move. In an implementation, the damping structure 80 comprises a first damping boss 801 provided on the detent 8 and a second damping boss 605 provided on the plug housing 6, a rear side of the first damping boss 801 is provided with a first damping ramp 8011, and a front side of the second damping boss 605 is provided with a second damping ramp 6051. As shown in FIG. 8, after pushing the detent 8 forward into place, the first damping boss 801 is located on the front side of the second damping boss 605. When the detent 8 moves to the rear side, the second damping boss 605 generates a resistance to the first damping boss 801, thereby preventing the detent 8 from moving to the rear side, so that the first boss 804 remains mated with the first torsion bar mechanism 601, and the second boss 805 remains mated with the second torsion bar mechanism 606. When the first damping ramp 8011 abuts against the second damping ramp 6051, the operator continues to increase an external force to the rear side, and under a guiding action of the first damping ramp 8011 and the second damping ramp 6051, the detent 8 will be deformed, the first damping boss 801 slides over the second damping boss 605, and the detent 8 continues to move to the rear side, thereby the first boss 804 deviates from the first torsion bar mechanism 601, and the second boss 805 deviates from the second torsion bar mechanism 606.

Through the damping structure 80, the position of the detent 8 on the plug housing 6 keeps stable, and the operator applies a large enough external force to unlock the detent 8, which is simple in structure, safe and reliable in connection, convenient in operation, and lower in manufacturing cost.

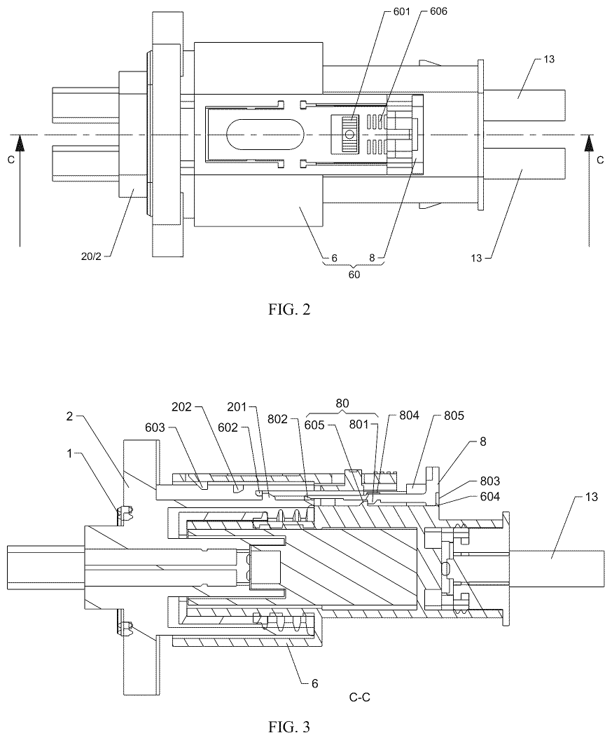

As shown in FIG. 2 and FIG. 3, when the plug connector 60 and the socket connector 20 are not plugged, the detent 8 is not pushed into place, the first damping boss 801 is located at the rear side of the second damping boss 605, the second damping boss 605 is capable of preventing the first damping boss 801 from moving forward to limit the detent 8.

As shown in FIG. 19 to FIG. 21, the front end of the detent 8 is provided with a first unlocking boss 802, the socket housing 2 is provided with a second unlocking boss 203, the second unlocking boss 203 is capable of pushing the first damping boss 801 to separate from the second damping boss 605 via the first unlocking boss 802. Specifically, when the plug connector 60 and the socket connector 20 are plugged, the second unlocking boss 203 pushes the first unlocking boss 802 to upwarp, the first unlocking boss 802 drives the first damping boss 801 to move upward, so that the first damping boss 801 can move from the rear side of the second damping boss 605 to its front side.

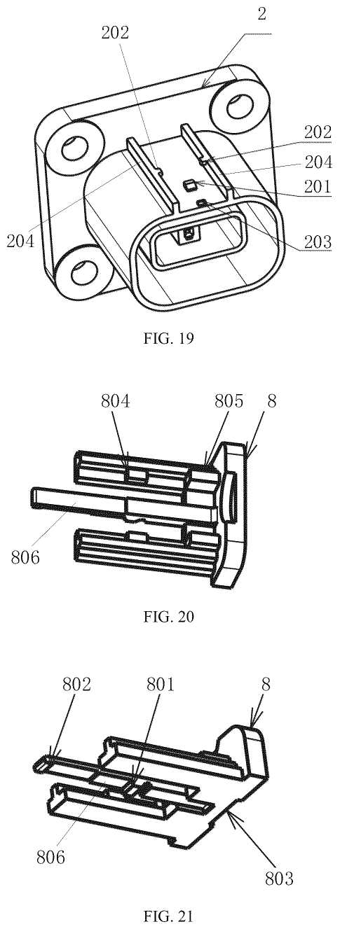

Further, the detent 8 has an unlocking arm 806, as shown in FIG. 20 and FIG. 21, the first unlocking boss 802 and the first damping boss 801 are provided on the unlocking arm 806, the first unlocking boss 802 is provided on the front side of the first damping boss 801, and when the plug connector 60 and the socket connector 20 are plugged, the second unlocking boss 203 pushes the first unlocking boss 802 to upwarp, and the unlocking arm 806 deforms upward, thereby driving the first damping boss 801 to move upward, which is convenient to operate. The detent 8 has the advantages of simple structure, convenient processing and smaller size, which is conducive to reducing the overall size of the electrical connection apparatus.

In an implementation, a rear end of the plug housing 6 is provided with a limit boss 604 to limit a range of the detent 8 to move to a rear side. Further, a rear end of the detent 8 is provided with a limit groove 803, as shown in FIG. 3, FIG. 17 and FIG. 21, the limit boss 604 limits the limit groove 803 to prevent the detent 8 from moving to the rear side. When the plug connector 60 and the socket connector 20 are not plugged, a position of the detent 8 is limited to a set range via the limit boss 604 and the second damping boss 605.

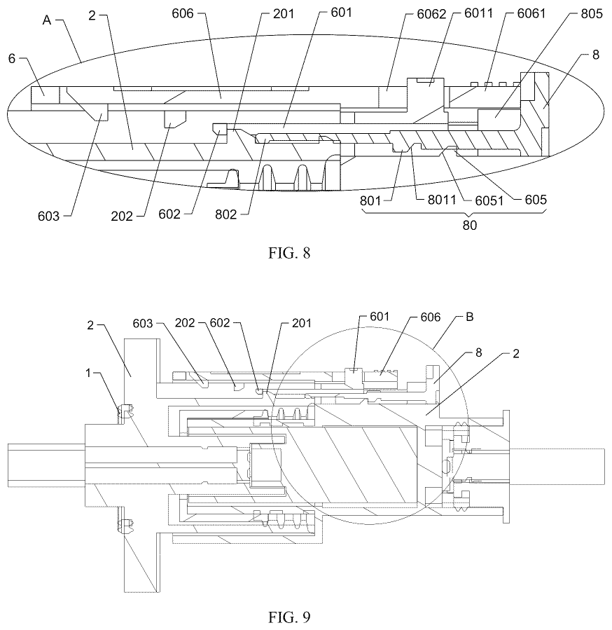

As shown in FIG. 9, the second lock hook 603 is provided on a front side of the first lock hook 602, and the second lock catch 202 is located on a front side of the first lock catch 201. In an implementation, a distance between the second lock hook 603 and the first lock hook 602 is greater than a distance between the second lock catch 202 and the first lock catch 201. When the first lock hook 602 abuts against the first lock catch 201, the second lock hook 603 is located on the front side of the second lock catch 202 and is some distance away: when the first lock hook 602 and the first lock catch 201 are unlocked and the plug connector 60 is moved to the rear side for a certain distance, the second lock hook 603 abuts against the second lock catch 202, the two mate to be locked; the operator continues to unlock the second torsion bar mechanism 606, and the second lock hook 603 and the second lock catch 202 are unlocked. In the electrical connection apparatus, the first-stage unlocking step and the second-stage unlocking step need to be operated step by step, which solves the problem of a time interval when an interlock signal circuit is disconnected from a power circuit and improves the security.

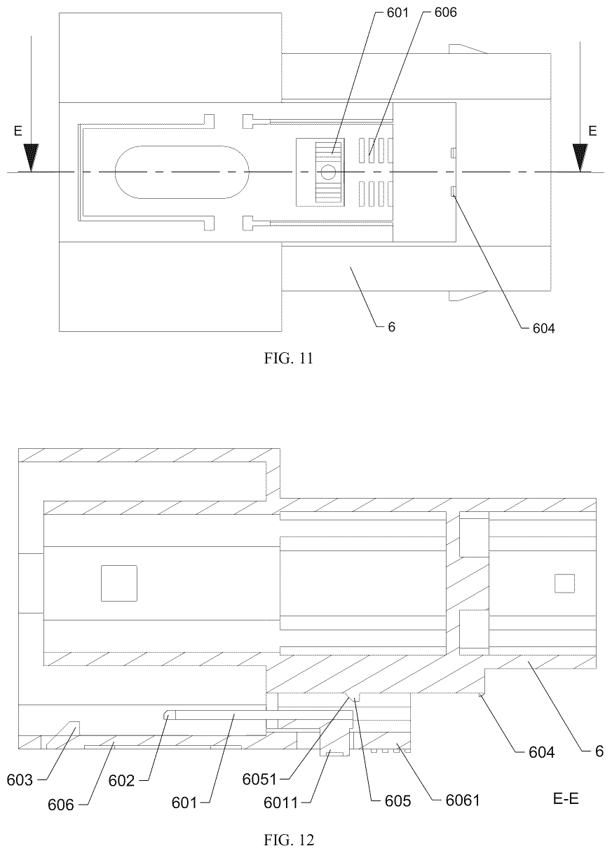

As shown in FIG. 11 to FIG. 18, the second lock hook 602 is provided at an inner side of the second lock hook 603. The first lock hook 602 is provided at a front end of the first torsion bar mechanism 601, a first pressing portion 6011 is provided at the rear end of the first torsion bar mechanism 601. The operator presses the first pressing portion 6011 inward to drive the first torsion bar mechanism 601 to move and to drive the first lock hook 602 to move outwardly, thereby disengaging from the first lock catch 201: when the first boss 804 of the detent 8 is located at an inner side of the first press portion 6011, it prevents the first press portion 6011 from moving inward under the press, so that the first lock hook 602 and the first lock catch 201 remain locked.

In an implementation, the area of a pressing surface of the first pressing portion 6011 is greater than or equal to 5 mm².

As shown in FIG. 12, the first press portion 6011 is manually pressed to make the first lock hook 602 disengage from the first lock catch 201, and the plug connector 60 is pulled to move in a pull-out direction. Therefore, the area of the pressing surface of the first pressing portion 6011 needs to be able to withstand a force of a human finger. The minimum area of this pressing surface is 5 mm², for example, it can be a plane with a 2 mm width and a 2.5 mm length, which can guarantee a finger to press down the first press portion 6011. The area of the pressing surface should not be too large, it is easy to be bumped or pressed during use if it is too large, and the first pressing portion 6011 is pressed, resulting in that the first lock hook 602 disengages from the first lock catch 201, resulting in unexpected interruption of a circuit system. According to an overall size of the electrical connection apparatus, the area of the pressing surface of the first pressing portion 6011 can be designed reasonably.

In order to verify the influence of the area of the pressing surface of the first pressing portion 6011 on pressing the first pressing portion 6011 by an operator, the inventor selected multiple sets of samples of the electrical connection apparatus of the same structure and size, the area of the pressing surface of the first pressing portion 6011 in each set of samples is different, there are 13 sets of samples in total, with 100 samples in each set. The operator discontinuously presses the pressing surface of the first pressing portion 6011 respectively, and disengages the first lock hook 602 from the first lock catch 201, and records a single operation success rate of the operator, which is recorded in Table 1. In this embodiment, it is unqualified if the single operation success rate of the operator is less than 95%.

TABLE 1
Influence of the area of the pressing surface of the first pressing portion
6011 on pressing the first pressing portion 6011 by an operator
Area (mm²) of the pressing surface of the first pressing portion 6011

| | | | | | | | | | | | | |
|---|---|---|---|---|---|---|---|---|---|---|---|---|
| 2 | 3 | 4 | 5 | 6 | 7 | 8 | 9 | 10 | 11 | 12 | 13 | 14 |

Single operation success rate of the operator (%)

| | | | | | | | | | | | | |
|---|---|---|---|---|---|---|---|---|---|---|---|---|
| 71 | 83 | 91 | 97 | 100 | 100 | 100 | 100 | 100 | 100 | 100 | 100 | 100 |

As can be seen from the above Table 1, the operator discontinuously presses the pressing surface of the first pressing portion 6011 and disengages the first lock hook 602 from the first lock catch 201, the influence of personnel fatigue is excluded, when pressing the first pressing portion 6011 with different areas of the pressing surface: when the area of the pressing surface of the first pressing portion 6011 is greater than 5 mm², all can be operated successfully; when the area of the pressing surface of the first pressing portion 6011 is equal to 5 mm², the operator made 3 errors, resulting that the single operation success rate of the operator is 97% but it is within a range of qualified values: when the area of the pressing surface of the first pressing portion 6011 is less than 5 mm², it is difficult for the operator to apply a force with fingers because the area of the pressing surface of the first pressing portion 6011 is too small, resulting in a reduction in the single operation success rate, being less than the range of qualified values. Therefore, the inventor set that the area of the pressing surface of the first pressing portion 6011 is greater than or equal to 5 mm².

In an implementation, the first pressing portion 6011 is subjected to a first pressing force, which drives the first torsion bar mechanism 601 to move and drives the first lock hook 602 to move to an outer side, thereby disengaging from the first lock catch 201, preferably, the first pressing force is less than or equal to 135N.

The first torsion bar mechanism 601 has certain elasticity, which can drive the first torsion bar mechanism 601 to move and drive the first lock hook 602 to move to an outer side in a case where the first pressing portion 6011 applies the first pressing force, so as to disengage from the first lock catch 201 and be able to return to the original position under the action of its own elasticity. If an elastic force of the first torsion bar mechanism 601 is too large, resulting in a need to apply a large first pressing force to deform the first torsion bar mechanism 601, then when the electrical connection apparatus needs to release primary locking, the operator needs to use a large force to make the first lock hook 602 disengage from the first lock catch 201, which wastes time and energy, and it may cause some damage to the operator's fingers.

In order to verify the influence of a magnitude of the first pressing force on pressing the first pressing portion 6011 by an operator, the inventor selected multiple sets of samples of the electrical connection apparatus of the same structure and size, a magnitude of elasticity of the first torsion bar mechanism 601 in each set of samples is different, there are 13 sets of samples in total, with 100 samples in each set. The operator discontinuously presses the first pressing portion 6011 respectively, and disengages the first lock hook 602 from the first lock catch 201, and records a single operation success rate of the operator, which is recorded in Table 2. In this embodiment, it is unqualified if the single operation success rate of the operator is less than 95%.

TABLE 2
Influence of a magnitude of the first pressing force on
pressing the first pressing portion 6011 by an operator
Magnitude (N) of the first pressing force

| | | | | | | | | | | | | |
|---|---|---|---|---|---|---|---|---|---|---|---|---|
| 10 | 20 | 40 | 60 | 80 | 100 | 110 | 120 | 130 | 135 | 140 | 145 | 150 |

Single operation success rate (%) of the operator

| | | | | | | | | | | | | |
|---|---|---|---|---|---|---|---|---|---|---|---|---|
| 100 | 100 | 100 | 100 | 100 | 100 | 100 | 100 | 100 | 96 | 87 | 64 | 55 |

As can be seen from the above Table 2, the operator discontinuously presses the first pressing portion 6011 and disengages the first lock hook 602 from the first lock catch 201, the influence of personnel fatigue is excluded, when pressing the first pressing portion 6011 with different elasticities: when the first pressing force is less than 130N, all can be operated successfully; when the first pressing force is 135N, the operator made 4 errors, resulting that the single operation success rate of the operator is 96% but it is within a range of qualified values: when the first pressing force exceeds 135N, it is difficult for the operator to apply a force with fingers because the first pressing force is too large, resulting in a reduction in the single operation success rate, being less than the range of qualified values. Thus, the inventor set the first pressing force to be less than or equal to 135N.

The second lock hook 603 is provided at a front end of the second torsion bar mechanism 606, a second pressing portion 6061 is provided at the rear end of the second torsion bar mechanism 606. The operator presses the second pressing portion 6061 inward to drive the second torsion bar mechanism 606 to move and to drive the second lock hook 603 to move outwardly, thereby disengaging from the second lock catch 202; when the second boss 805 of the detent 8 is located at an inner side of the second press portion 6061, it prevents the second press portion 6061 from moving inward under the press, so that the second lock hook 603 and the second lock catch 202 remain locked.

In an implementation, the area of a pressing surface of the second pressing portion 6061 is greater than or equal to 5 mm².

When the electrical connection apparatus needs to release secondary locking, the second press portion 6061 needs to be manually pressed to make the second lock hook 603 disengage from the second lock catch 202, and the plug connector 60 is pulled to move in a pull-out direction. Therefore, the second pressing portion 6061 needs a pressing surface that can withstand the force of human fingers. The minimum area of this pressing surface is 5 mm², for example, it can be a plane with a 2 mm width and a 2.5 mm length, which can guarantee a finger to press down the pressing surface. The area of the pressing surface should not be too large, it is easy to be bumped or pressed during use if it is too large, and the second pressing portion 6061 is pressed, resulting in that the second lock hook 603 disengages from the second lock catch 202, resulting in unexpected interruption of a circuit system. According to an overall size of the electrical connection apparatus, the area of the pressing surface can be designed reasonably.

In order to verify the influence of the area of the pressing surface on pressing the second pressing portion 6061 by an operator, the inventor selected multiple sets of samples of the electrical connection apparatus of the same structure and size, the area of the pressing surface in the sets of samples is different, there are 13 sets of samples in total, with 100 samples in each set. The operator discontinuously presses different pressing surfaces respectively, and disengages the second lock hook 603 from the second lock catch 202, and records a single operation success rate of the operator, which is recorded in Table 3. In this embodiment, it is unqualified if the single operation success rate of the operator is less than 95%.

TABLE 3
Influence of the area of the pressing surface of the second pressing portion
6061 on pressing the second pressing portion 6061 by an operator
Area (mm²) of the pressing surface of the second pressing portion 6061

| | | | | | | | | | | | | |
|---|---|---|---|---|---|---|---|---|---|---|---|---|
| 2 | 3 | 4 | 5 | 6 | 7 | 8 | 9 | 10 | 11 | 12 | 13 | 14 |

Single operation success rate (%) of the operator

| | | | | | | | | | | | | |
|---|---|---|---|---|---|---|---|---|---|---|---|---|
| 69 | 82 | 90 | 97 | 100 | 100 | 100 | 100 | 100 | 100 | 100 | 100 | 100 |

As can be seen from the above Table 3, the operator discontinuously presses different pressing surfaces and disengages the second lock hook 603 from the second lock catch 202, the influence of personnel fatigue is excluded, when pressing the second pressing portion 6061 with different areas of the pressing surface, when the area of the pressing surface is greater than 5 mm², all can be operated successfully; when the area of the pressing surface is equal to 5 mm², the operator made 3 errors, resulting that the single operation success rate of the operator is 97% but it is within a range of qualified values; when the area of the pressing surface is less than 5 mm², it is difficult for the operator to apply a force with fingers because the area of the pressing surface is too small, resulting in a reduction in the single operation success rate, being less than the range of qualified values. Therefore, the inventor set that the area of the pressing surface of the second pressing portion 6061 is greater than or equal to 5 mm².

In an implementation, the second pressing portion 6061 is subjected to a second pressing force, which drives the second torsion bar mechanism 606 to move and drives the second lock hook 603 to move to an outer side, thereby disengaging from the second lock catch 202, preferably, the second pressing force is less than or equal to 135N.

In order to verify the influence of a magnitude of the second pressing force on pressing the second pressing portion 6061 by an operator, the inventor selected multiple sets of samples of the electrical connection apparatus of the same structure and size, a magnitude of a second pressing force of the second pressing portion 6061 in the sets of samples is different, there are 13 sets of samples in total, with 100 samples in each set. The operator discontinuously presses the second pressing portion 6061 respectively, and disengages the second lock hook 603 from the second lock catch 202, and records a single operation success rate of the operator, which is recorded in Table 4. In this embodiment, it is unqualified if the single operation success rate of the operator is less than 95%.

TABLE 4
Influence of a magnitude of the second pressing force on
pressing the second pressing portion 6061 by an operator
Magnitude (N) of the second pressing force

| | | | | | | | | | | | | |
|---|---|---|---|---|---|---|---|---|---|---|---|---|
| 10 | 20 | 40 | 60 | 80 | 100 | 110 | 120 | 130 | 135 | 140 | 145 | 150 |

Single operation success rate (%) of the operator

| | | | | | | | | | | | | |
|---|---|---|---|---|---|---|---|---|---|---|---|---|
| 100 | 100 | 100 | 100 | 100 | 100 | 100 | 100 | 100 | 97 | 89 | 67 | 58 |

As can be seen from the above Table 4, the operator discontinuously presses the second pressing portion 6061 and disengages the second lock hook 603 from the second lock catch 202, the influence of personnel fatigue is excluded, when pressing the second pressing portion 6061 having different second pressing forces: when the second pressing force is less than 130N, all can be operated successfully; when the second pressing force is 135N, the operator made 3 errors, resulting that the single operation success rate of the operator is 97% but it is within a range of qualified values; when the second pressing force exceeds 135N, it is difficult for the operator to apply a force with fingers because the second pressing force is too large, resulting in a reduction in the single operation success rate, being less than the range of qualified values. Thus, the inventor set the second pressing force to be less than or equal to 135N.

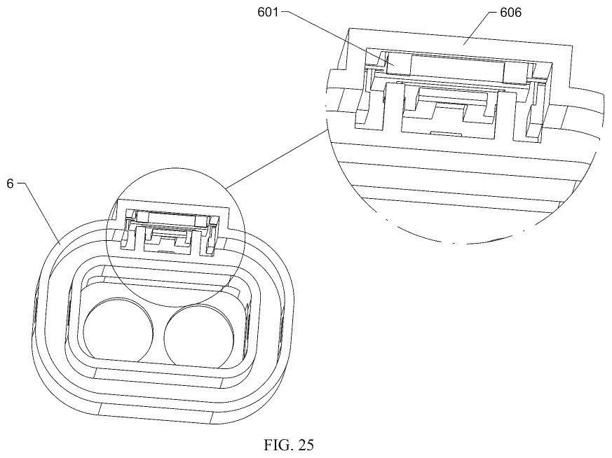

Further, the second torsion bar mechanism 606 is provided with a pressing through-hole 6062, as shown in FIGS. 6-8 and FIG. 25; the first torsion bar mechanism 601 is provided at an inner side of the second torsion bar mechanism 606, and the first pressing portion 6011 is provided in the pressing through-hole 6062. Both the first torsion bar mechanism 601 and the second torsion bar mechanism 606 are provided in the plug housing 6, the first torsion bar mechanism 601 and the second torsion bar mechanism 606 are independent of each other; the detent 8 is connected to the plug housing 6 to achieve a secondary lock function, the structure is relatively simple, the number of parts is reduced, the operation is easy, the connection is safe and reliable, and the manufacturing cost is low. Preferably, the first torsion bar mechanism 601 and the second torsion bar mechanism 606 are integrated with the plug housing 6.

In an implementation, the number of times of plugging and unplugging between the socket connector 20 and the plug connector 60 is greater than or equal to 9.

When assembling a high-voltage connection apparatus, the socket connector 20 and the plug connector 60 need to be assembled together. During subsequent maintenance and component disassembly, it may be necessary to separate the socket connector 20 and the plug connector 60 first and then to plug and unplug, thus the number of times of plugging and unplugging between the socket connector 20 and the plug connector 60 cannot be less than 9. If it is less than 9, the socket connector 20 and the plug connector 60 may be damaged during a disassembly and maintenance process, and cannot play the role of connecting a current, resulting in a need to replace the entire electrical connection apparatus including a wiring harness, which not only consumes the maintenance time, but also increases the maintenance cost. Therefore, material selection of the socket connector 20 and the plug connector 60, and design of a plugging and unplugging mechanism, a locking mechanism and a sealing mechanism between the socket connector 20 and the plug connector 60 need to ensure that they can undergo disassembly and assembly for at least 9 times, so that the requirements on use of the electrical connection apparatus can be met.

In an implementation, a weight of the plug connector 60 is less than or equal to 305 g.

Under normal circumstances, the socket connector 20 is fixed in a use environment, the plug connector 60 is located above the electrical connection apparatus and is plugged and fixed with the socket connector 20, and when the weight of the plug connector 60 is too large, the socket connector 20 is subject to greater gravity, and in the case of vibration of an electrical apparatus, it will lead to the entire electrical connection apparatus to follow the vibration, due to inertia, the plug connector 60 will be subjected to larger vibration and will emit abnormal sound, and in the use of the electrical connection apparatus, emitting abnormal sound is not allowed.

In order to verify the influence of the weight of the plug connector 60 on emitting abnormal sound by the electrical connection apparatus, the inventor used a sample of the electrical connection apparatus assembled with the same socket connector 20 and the plug connectors 60 with different weights to install it on a vibration test bench, and conducted a vibration test to observe whether the plug connector 60 emits abnormal sound during the vibration test. A test result is shown in Table 5.

TABLE 5
Influence of the weight of the plug connector 60 on emitting
abnormal sound by the electrical connection apparatus

| | Weight (g) | | | | | | | | |
|---|---|---|---|---|---|---|---|---|---|
| | 265 | 275 | 285 | 295 | 305 | 315 | 325 | 335 | 345 |
| Whether | No | No | No | No | No | Yes | Yes | Yes | Yes |
| to emit | | | | | | | | | |
| abnormal | | | | | | | | | |
| sound | | | | | | | | | |

As can be known from Table 5, when the weight of the plug connector 60 is greater than 305 g, the plug connector 60 emits abnormal sound during the vibration test, upon test, it is not qualified. Thus, the inventor set a weight of the plug connector 60 to be less than or equal to 305 g.

In an implementation, a height of the plug connector 60 in a plugging and unplugging direction is less than or equal to 208 mm.

After the socket connector 20 and the plug connector 60 are assembled together, they need to be installed in an electrical environment, but under normal circumstances, a space reserved for the electrical environment is smaller, if the plug connector 60 is higher, first, it cannot be installed in the electrical environment, second, raw materials are wasted, so the plug connector 60 needs to be lower than a certain height at the time of designing.

In order to verify the influence of the height of the plug connector 60 in a plugging and unplugging direction on installation of the electrical connection apparatus, the inventor used samples of the electrical connection apparatus assembled with the same socket connector 20 and the plug connectors 60 with different heights in a plugging and unplugging direction and install each of them on an electrical apparatus, to observe whether the plug connector 60 interferes with other components and parts in the electrical environment during installation. A test result is shown in Table 6.

As can be known from Table 6, when the height of the plug connector 60 in a plugging and unplugging direction is greater than 208 mm, it cannot be installed in a specified position of the electrical connection apparatus, upon test, it is not qualified. Thus, the inventor set a height of the plug connector 60 in a plugging and unplugging direction to be less than or equal to 208 mm.

TABLE 6
Influence of the height of the plug connector 60 in a plugging and unplugging
direction on installation of the electrical connection apparatus

| | Height (mm) | | | | | | | | |
|---|---|---|---|---|---|---|---|---|---|
| | 168 | 178 | 188 | 198 | 208 | 218 | 228 | 238 | 248 |
| Whether to | No | No | No | No | No | Yes | Yes | Yes | Yes |
| interfere or | | | | | | | | | |
| not | | | | | | | | | |

The method of using the electrical connection apparatus includes a locking step and an unlocking step.

The locking step includes: (1) after the plug connector 60 is plugged with the socket connector 20, the second unlocking boss 203 lifts the first unlocking boss 802, at this moment, a limiting function of the second limit boss 604 on the first damping boss 801 disappears, and the detent 8 can be pushed forward: (2) when the detent 8 is pushed into place, the first lock catch 201 and the first lock hook 602 fit to be locked; at the same time, the first boss 804 presses against the first pressing portion 6011 of the first torsion bar mechanism 601, and the second boss 805 presses against the second pressing portion 6061 of the second torsion bar mechanism 606, so that the first-stage lock and the second-stage lock cannot be unlocked.

The unlocking step includes: (1) pulling out the detent 8 in a back side direction: (2) pressing the first pressing portion 6011, and unlocking the plug connector 60 backwards, at this moment, the first lock hook 602 and the first lock catch 201 are unlocked successfully: (3) continuing to unlock the plug connector 60 backwards, at this moment, the second lock hook 603 and the second lock catch 202 fit to be locked; (4) pressing the second pressing portion 6061, and continuing to unlock the plug connector 60 backwards, at this moment, the second lock hook 603 and the second lock catch 202 are unlocked.

In an implementation, the socket housing 2 is provided with at least two guide studs 204, as shown in FIG. 19, the second lock catch 202 is provided on the guide studs 204, and the first lock catch 201 is provided between at least two guide studs 204, as shown in FIG. 19, the second detent catch 202 is provided respectively on two guide studs 204, two second lock catches 202 are distributed at both sides of the first lock catch 201, the second lock hook 603 on the plug housing 6 mates with the second lock catches 202 on both sides, which improves the reliability of the mating lock.

Considering that in the process of use, the plug connector 60 and the socket connector 20 need to be unplugged and plugged frequently, a terminal is easy to fall off under a stress during the process of unplugged and plugging, and when the positioning structure fails, a contact will be disengaged, resulting in the failure of a connector: moreover, in the process of use, the connector will be subject to vibration and sway, the wiring harness 13 at the tail of the plug connector 60 has a possibility of long-term deflection, which increases a stress on the terminal and has a risk of water leakage. To this end, the inventor made a further improvement to the electrical connection apparatus; the plug housing 6 is provided with a shielded outer crimping sleeve 11, a shielded inner crimping sleeve 12 and a TPA snap ring 9, the shielded outer crimping sleeve 11 and the shielded inner crimping sleeve 12 are crimped outside a shielding layer of a wiring harness 13, and the TPA snap ring 9 is sleeved outside the shielded outer crimping sleeve 11, the TPA snap ring 9 mates with the shielded outer crimping sleeve 11 and the shielded inner crimping sleeve 12 on the wiring harness 13, playing a terminal retention role.

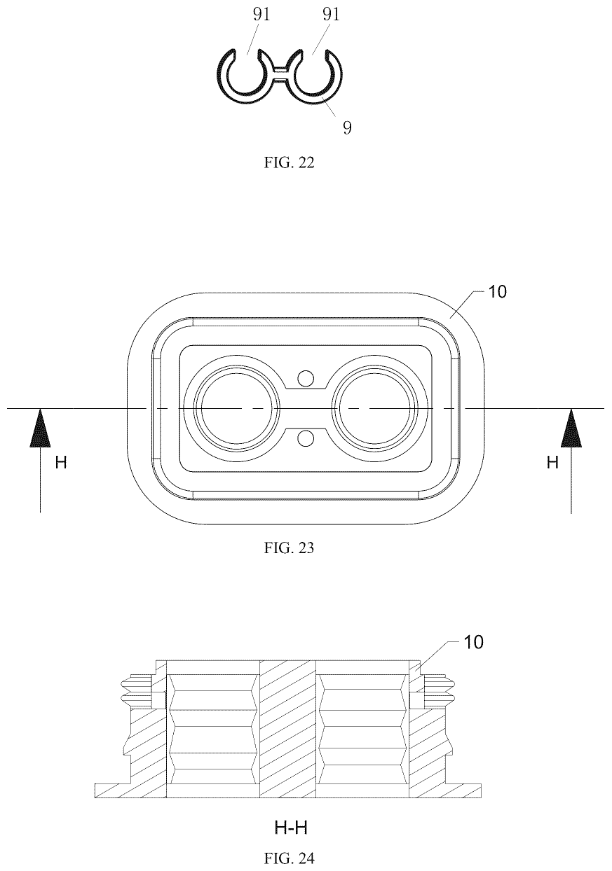

A rear end of the plug housing 6 is connected with a plug tail cover 10, the plug tail cover 10 is provided with a tail sealing ring, and the tail sealing ring mates with the plug housing 6. The TPA snap ring 9, the plug tail cover 10, the tail sealing ring, the shielded outer crimping sleeve 11 and the shielded inner crimping sleeve 12 work together to limit occurrence of deflection of the wiring harness 13 at the tail and avoid a risk of water leakage. The TPA snap ring 9 is installed in front of the plug tail cover 10, and is configured to perform secondary locking on the shielded outer crimping sleeve 11, the shielded inner crimping sleeve 12 and the wiring harness 13 to prevent them from loosening. As shown in FIG. 22, the TPA snap ring 9 is provided with a snap ring opening 91, a width of the snap ring opening 91 being smaller than a diameter of the shielded outer crimping sleeve 11, to confine the wiring harness 13. The plug tail cover 10 and the tail seal ring are injected molded together, the tail seal ring mates with the plug housing 6, which reduces the number of parts, reduces the cost, and plays a better limiting role on the wiring harness 13 to reduce a failure risk.

The wiring harness 13 is connected to the rear end of the plug housing 6, the shielded outer crimping sleeve 11 and the shielded inner crimping sleeve 12 are sleeved outside the wiring harness 13. As shown in FIG. 1-FIG. 24, the socket connector 20 further comprises a sealing gasket 1 connected to the rear end of the socket housing 2. The plug connector 60 further comprises a cover plate 3, a plug insulator 4, a shorting pin 5 and a head seat sealing ring 7. The cover plate 3, the plug insulator 4, the shorting pin 5 and a head seat sealing ring 7 are all fixedly provided in the plug housing 6. The plug connector 60 may be assembled according to the following steps:
(1) installing a plug shield on the plug insulator 4;
(2) then installing the shorting pin 5 on the plug insulator 4;
(3) putting the assembled plug insulator 4 into the plug housing 6;
(4) putting the head seat sealing ring 7;
(5) installing the cover plate 3;
(6) sleeving the plug tail cover 10 on a wiring harness;
(7) after stripping the wire harness as required, crimping a terminal, the shielded outer crimping sleeve 11 and the shielded inner crimping sleeve 12;
(8) after installing the TPA snap ring 9 on the crimped wiring harness, mounting a wiring harness assembly into the plug connector 60.

### Solution 2

The present disclosure provides a plug connector, as shown in FIGS. 11-18, the plug connector includes: a plug housing 6 and a detent 8, the plug housing 6 is provided with a first torsion bar mechanism 601, the first torsion bar mechanism 601 is provided with a first lock hook 602, the first torsion bar mechanism 601 is capable of driving the first lock hook 602 to move under an action of an external force; the detent 8 is provided with a first boss 804 and is connected with the plug housing 6 and is limited by a damping structure 80, the damping structure 80 is capable of preventing the first boss 804 from deviating from the first torsion bar mechanism 601, and the first boss 804 is capable of preventing the first torsion bar mechanism 601 from moving under an action of an external force. The plug connector is connected with a mating socket connector, and the plug housing 6 keeps locked with a socket housing 2 via the detent 8; when unlocking, the operator applies an external force to overcome a resistance generated by the damping structure 80, and applies an external force to the first torsion bar mechanism 601, the first torsion bar mechanism 601 drives the first lock hook 602 to move to achieve unlocking, which can ensure safety of locking and disconnection of electrical connection, is convenient to operate, has a simpler structure and reduces the manufacturing cost.

The above contents are only schematic embodiments of the present disclosure and are not intended to limit the scope of the present disclosure. An equivalent change and amendment made by any person skilled in the art without deviating from the idea and principle of the present disclosure should fall into the scope protected by the present disclosure.

1. An electrical connection apparatus, wherein the electrical connection device comprises: a socket connector and a plug connector, the socket connector comprising a socket housing, the plug connector comprising a plug housing and a detent, and a front end of the plug housing being plugged into the socket housing;
an outer wall of the socket housing is provided with a first lock catch; the plug housing is provided with a first torsion bar mechanism, the first torsion bar mechanism being provided with a first lock hook, the first lock hook being snapped at a front side of the first lock catch, to prevent the plug housing from moving backward with respect to the socket housing, and the first torsion bar mechanism is capable of driving the first lock hook to separate from the first lock catch under an action of an external force; and
the detent is provided with a first boss, and is connected with the plug housing, the first boss is capable of preventing the first torsion bar mechanism from moving under an action of an external force.

2. The electrical connection apparatus according to claim 1, wherein the detent and the plug housing are limited via a damping structure, the damping structure being capable of preventing the first boss from deviating from the first torsion bar mechanism.

3. The electrical connection apparatus according to claim 2, wherein an outer wall of the socket housing is provided with a second lock catch; the plug housing is provided with a second torsion bar mechanism, the second torsion bar mechanism being provided with a second lock hook, the second lock hook being snapped at a front side of the second lock catch, to prevent the plug housing from moving backward with respect to the socket housing, and the second torsion bar mechanism is capable of driving the second lock hook to separate from the second lock catch under an action of an external force; and
the detent is provided with a second boss, the damping structure is capable of preventing the second boss from deviating from the second torsion bar mechanism, and the second boss is capable of preventing the second torsion bar mechanism from moving under an action of an external force.

4. The electrical connection apparatus according to claim 2, wherein the damping structure comprises a first damping boss provided on the detent and a second damping boss provided on the plug housing, a rear side of the first damping boss is provided with a first damping ramp, and a front side of the second damping boss is provided with a second damping ramp.

5. The electrical connection apparatus according to claim 4, wherein the second damping boss is capable of preventing the first damping boss from moving forward;
a front end of the detent is provided with a first unlocking boss, the socket housing is provided with a second unlocking boss, and the second unlocking boss is capable of pushing the first damping boss to separate from the second damping boss via the first unlocking boss.

6. The electrical connection apparatus according to claim 3, wherein
the second lock hook is provided at a front side of the first lock hook.

7. The electrical connection apparatus according to claim 6, wherein a distance between the second lock hook and the first lock hook is greater than a distance between the second lock catch and the first lock catch.

8. The electrical connection apparatus according to claim 6, wherein the first lock hook is provided at an inner side of the second lock hook.

9. The electrical connection apparatus according to claim 3, wherein the socket housing is provided with at least two guide studs, the second lock catch is provided on the guide studs, and the first lock catch is provided between the at least two guide studs.

10. The electrical connection apparatus according to claim 1, wherein the plug housing is provided with a shielded outer crimping sleeve, a shielded inner crimping sleeve and a TPA snap ring, the shielded outer crimping sleeve and the shielded inner crimping sleeve are crimped outside a shielding layer of a wiring harness, and the TPA snap ring is sleeved outside the shielded outer crimping sleeve.

11. The electrical connection apparatus according to claim 10, wherein the TPA snap ring is provided with a snap ring opening, a width of the snap ring opening being smaller than a diameter of the shielded outer crimping sleeve.

12. The electrical connection apparatus according to claim 11, wherein a rear end of the plug housing is connected with a plug tail cover, the plug tail cover is injected-molded with a tail sealing ring, and the tail sealing ring is fit with the plug housing.

13. The electrical connection apparatus according to claim 3, wherein the first lock hook is provided at a front end of the first torsion bar mechanism, and a rear end of the first torsion bar mechanism is provided with a first pressing portion; and
the second lock hook is provided at a front end of the second torsion bar mechanism, a rear end of the second torsion bar mechanism is provided with a second pressing portion; the second torsion bar mechanism is provided with a pressing through-hole, the first torsion bar mechanism is provided at an inner side of the second torsion bar mechanism, and the first pressing portion is provided in the pressing through-hole.

14. The electrical connection apparatus according to claim 1, wherein a rear end of the plug housing is provided with a limit boss, the limit boss being configured to limit a range of movement of the detent to a rear side.

15. A plug connector, comprising: a plug housing and a detent, the plug housing being provided with a first torsion bar mechanism, the first torsion bar mechanism being provided with a first lock hook, and the first torsion bar mechanism being capable of driving the first lock hook to move under an action of an external force; and
the detent is provided with a first boss, the detent is connected with the plug housing and is limited via a damping structure, the damping structure is capable of preventing the first boss from deviating from the first torsion bar mechanism, and the first boss is capable of preventing the first torsion bar mechanism from moving under an action of an external force.

16. The electrical connection apparatus according to claim 3, wherein the damping structure comprises a first damping boss provided on the detent and a second damping boss provided on the plug housing, a rear side of the first damping boss is provided with a first damping ramp, and a front side of the second damping boss is provided with a second damping ramp.

17. The electrical connection apparatus according to claim 16, wherein the second damping boss is capable of preventing the first damping boss from moving forward;
a front end of the detent is provided with a first unlocking boss, the socket housing is provided with a second unlocking boss, and the second unlocking boss is capable of pushing the first damping boss to separate from the second damping boss via the first unlocking boss.
